(19) United States
(12) Patent Application Publication
(10) Pub. No.: US 2020/0271259 A1
(43) Pub. Date: Aug. 27, 2020

(54) Safety System for High Pressure Conduits

(71) Applicant: Andrew Charles Abrams, Bryn Mawr, PA (US)

(72) Inventor: Andrew Charles Abrams, Bryn Mawr, PA (US)

(21) Appl. No.: 16/281,306

(22) Filed: Feb. 21, 2019

(51) Int. Cl. F16L 35/00; F16L 55/00

(52) U.S. Cl. CPC F16L 35/00; F16L 55/005

(57) ABSTRACT

A fluid delivery system having a safety system with interchangeable parts. Also a safety system having a conduit specifically designed to withstand ultra high-pressure fluids exceeding 24,000 psi.

### FIELD OF THE DISCLOSED TECHNOLOGY

The disclosed technology relates to safety conduit system for a fluid delivery handling system and particularly to a conduit and fittings configured to withstand high-pressure fluids.

### BACKGROUND OF THE DISCLOSED TECHNOLOGY

There are many instances where fluids are delivered at high pressure through a system of conduits. There is a significant risk associated with failure of such handling systems. Unintentional release of these fluids poses significant health risks as well as the risk of property damage. When a handling system fails, by rupturing or splitting, there are safety systems that can contain the discharge of liquids or gases. With the arrival of new conduits made of material especially designed for ultra high-pressure fluids exceeding 24,000 psi, there is a need for a safety conduit system that can function in that environment.

An additional need in the technology of high-pressure delivery systems is a safety conduit system where, if only one component fails, the whole system does not need to be replaced. Thus, a safety conduit system with interchangeable components would provide economic benefit to the end user.

### SUMMARY OF THE DISCLOSED TECHNOLOGY

Aspects of the disclosed technology, according to some embodiments thereof, relate to providing a safety conduit system comprising a conduit having a first and second end and a fitting at each end of the conduit defining a valve seat. Further, valve bodies in each fitting are configured to connect to a valve seat, at the time of failure of a conduit, resulting in valve closure.

One objective is to have a safety conduit system, as part of a handling system of conduits and additional elements needed in the handling system. The safety conduit system having a high-pressure conduit that can withstand pressure in excess of approximately 24,000 psi. Further, a unique fixture of the safety conduit system is configured to attach the fixture to the high-pressure conduit. Optionally, fixture features configured for further customizable replacements when needed in the safety conduit system.

Another objective is to have a safety system where the components include a safety fitting, an elbow, conduit and an additional safety fitting thereby protecting the entire assembly in case of a failure.

In a further objective of the disclosed technology the ability to lift and carry a Safety hose can be facilitated by the inclusion of handles integrated to each fitting.

In yet another objective is to have a safety conduit system comprising a conduit having first and second ends and inner and outer surfaces, with the conduit configured to withstand pressures exceeding 24,000 psi and a fitting at each end of the conduit defining a valve seat configured to accept a valve body to define a closed valve. Also a means for keeping valve bodies and seats at an open position until conduit failure and means for movement of the valve body to meet valve seat to close a valve upon conduit fails, wherein the fitting further comprises a tapered barbed segment on one end configured to fit into and connect the fitting to an inner portion on either end of the conduit.

In an objective the safety system wherein the material for the conduit is Polyethylene-co-tetrafluoroethylene or Ethylene Tetrafluoroethylene. Also the material for the conduit can withstand a burst pressure of between about 12,000 to 40,000 psi. The fitting of the safety system comprises a tapered segment on one end and an opposite end having means to removably attach to a handling system of conduits, and tapered section has a plurality barbed teeth configured to be placed inside conduit and prevent removal of fixture from the conduit.

One objective of the safety system is the plurality of barbed teeth is 5 or more barbed teeth, and the conduit further comprises a tubular core having inner and outer surfaces and further configured to have a plurality of tubular layers surrounding the outer surface of the tubular core; and an outer containment sleeve having an inner and outer surface the inner surface of the outer containment sleeve is surrounding the outer surface of the plurality of tubular layers. The safety system also comprising and elbow connection configured to connect the conduit to the fixture.

In a final objective, an aperture on the fixture configured to receive a safety loop connected to the fixture, and/or comprising a handle configured to attach to said fixture. The tapered end of the fixture has means to removably attach to the conduit of the safety conduit system, and the fixtures and the conduits are removably attached at each respective ends, such that the system has interchangeable components. The means to removably attach are mating screw threads. The safety system for conduits of comprising a crimp configured to secure attachment of the fitting to the conduit wherein said crimp is of at least 1 -10 centimeters in length on the end of said conduit.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1 shows a partial view of the safety conduit system before fixture attachment to the conduit of the disclosure.

FIG. 2 shows a partial view the safety conduit system with an embodiment of the fixture before attachment to the conduit of the disclosure.

FIG. 3 is a cut away partial view, of a fixture of the disclosure

FIG. 4 is a cut away partial view of a conduit safety system of the disclosure.

FIG. 5 is a partial view, according to some embodiments, of the safety conduit system with different external positioning devices of the disclosure.

FIG. 6 is partial view, according to some embodiments, of the safety conduit system with an elbow conduit element of the disclosure.

FIG. 7 is a prospective view of a complete safety conduit system in some embodiments of the disclosure.

FIG. 8 is a side plain view of a fixture of the disclosure.

A better understanding of the disclosed technology will be obtained from the following detailed description of the preferred embodiments, taken in conjunction with the drawings and the attached claims.

### DETAILED DESCRIPTION OF EMBODIMENTS OF THE DISCLOSED TECHNOLOGY

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. Unless otherwise indicated, the word “or” in the description and claims is considered to be the inclusive “or” rather than the exclusive or, and indicates at least one of, or any combination of more than one of items it conjoins.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

The terms “conduit” or “hose” as used herein are interchangeable in meaning.

To aid in describing the disclosed technology, directional terms may be used in the specification and claims to describe portions of the present technology (e.g., upper, lower, left, right, etc.). These directional definitions are merely intended to assist in describing and claiming the disclosed technology and are not intended to limit the disclosed technology in any way. In addition, reference numerals that are introduced in the specification in association with a drawing figure may be repeated in one or more subsequent figures without additional description in the specification, in order to provide context for other features.

With reference now to the drawings, a device is shown for a safety conduit system for fluid.

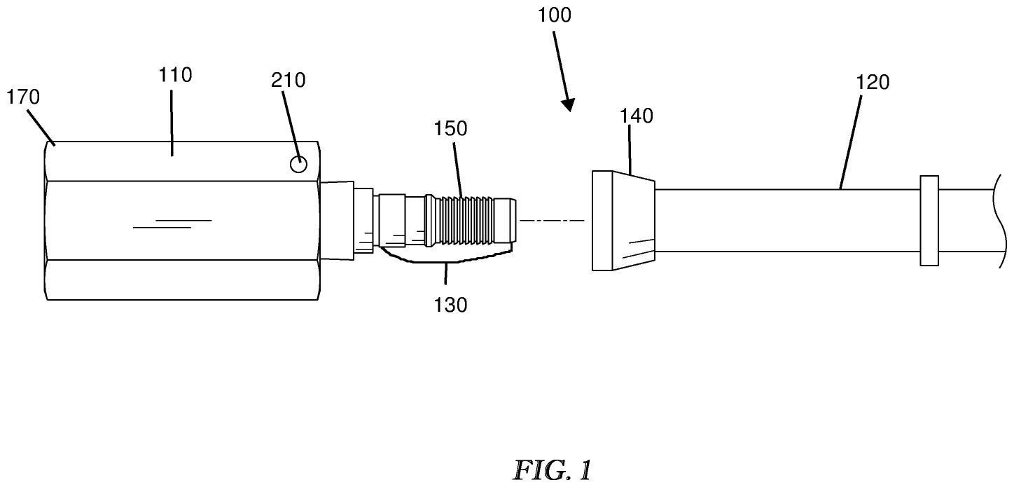

Referring to FIG. 1, reference number 100 refers generally to a safety conduit system. Fixture 110 is configured to connect high-pressure conduit 120 to elements, hoses and conduits of a handling system. The handling system is typically used for movement of gases and/or liquids. In an embodiment, there is a second end of the high-pressure conduit 120 having a second fixture 110, also for connecting to other elements in the handling system.

Optionally, high-pressure conduit 120 is made from ETFE and handles burst pressures of fluids travelling though of about 12,000-psi to 40,000-psi. ETFE, specifically, polyethylene-co-tetrafluoroethylene is an ultra high pressure smoothbore EFTE (Ethylene tetrafluoroethylene). ETFE is a fluorine-based plastic. It was designed to have high corrosion resistance and strength over a wide temperature range. ETFE is a polymer and its source-based name is poly(ethene-co-tetrafluoroethene). ETFE has a relatively high melting temperature, excellent chemical, electrical and high-energy radiation resistance properties. More specifically, the conduit may have properties of an ETFE of 6,000 psi working pressure and 24,000 psi burst pressure. In some embodiments, the high-pressure conduit 120 is a general conduit handling substances less than 24000 psi. Conduit 120, optionally may have a high flexibility.

In an embodiment the fixture 110 has two ends, one end having a tapered section 130. The tapered section 130 is used for connection to conduit 120. Tapered section 130 is placed into an end of conduit 120 and optionally crimp 140 secures tapered end 130 of fixture 110 inside a circumference of conduit 120. Crimp 140 optionally is longer than a crimp well known in the art of about 1-10 centimeter or more.

Although fixture 110 is shown with tapered end 130 fitting into conduit 120, optionally, fixture 110 is wider in diameter than conduit 120 such that conduit 120 is connected inside circumference of the fitting 110. When using the ETFE conduit 120, one option is to use barbed teeth 150 on tapered section 130. The barbed teeth 150 have one-way sharpness so that the tapered end 130 easily fits into the end and inside the circumference of conduit 120. Therefore, barbed teeth 150 cause excessive friction when trying to remove fixture 110 from conduit 120 increasing the strength of the attachment. Optionally, barbed teeth 150 would be comprised of 5 or more rows to further strengthen the attachment.

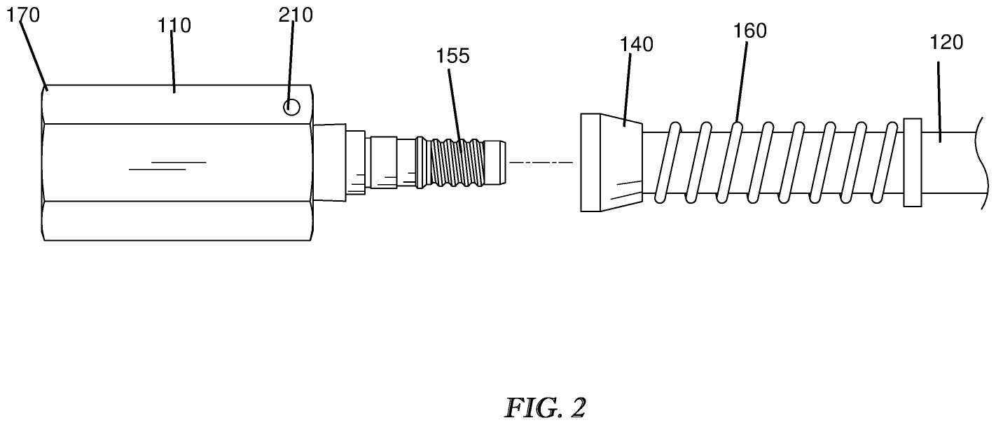

FIG. 2 illustrates a similar configuration of the safety conduit system 100 of FIG. 1 with two additional options. Bend restrictor 160 around conduit 120 is used to reduce the flexibility of conduit 120 at the attachment point adjacent to fixture 110. Tapered end 130 has screw threads 155, which is another option for a stable attachment of fixture 110 to conduit 120. These screw threads 155 optionally are in addition to barbed teeth 150. Screw threads 155 are used with mating screw threads on the inside of conduit 120 (not shown).

Fixture 110 tapered end 130 again may have a non tapered wider circumference than the conduit 120 and have screw threads on it's inner circumference which connect to the outer circumference of the conduit 120 having mating screw threads. Further, the opposite end 170 of fixture 110 also may have screw threads, inside and/or outside the circumference for mating with screw threads on one of the elements of the handling system. This screw thread system is useful to replace individual parts of the conduit safety system 100. As a result, the entire safety system 100 does not need to be replaced when failure and/or wearing down of parts occurs.

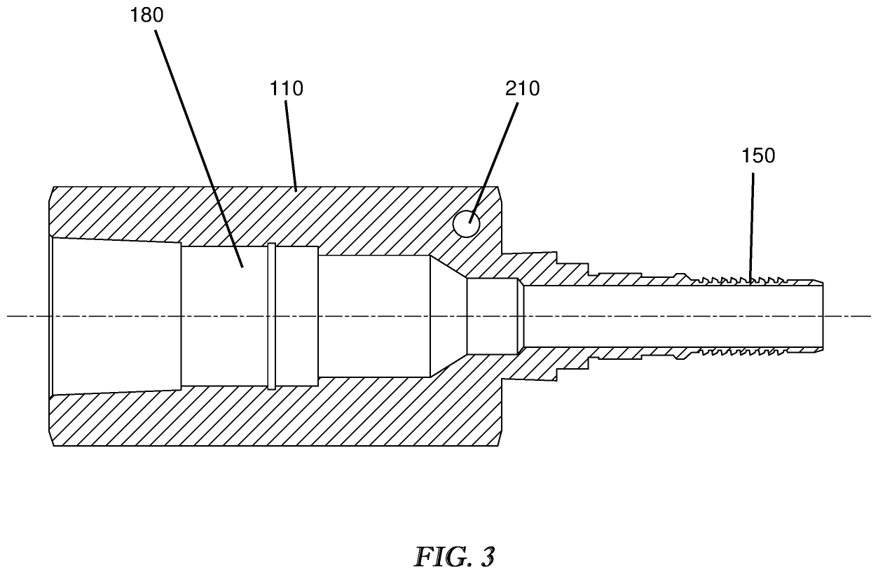

FIG. 3, by way of example, schematically illustrates inner diameters 180 of fixture 110 configured to accept a valve system (not shown). A valve system used for changing a valve body and/or valve seat position, which closes or connects the valve body and valve seat at failure of the safety conduit system 100 creates a closed valve. Any well-known means in the art for changing valve body positions and/or valve seats consistent with the current disclosure may be used.

By way of example, when a valve body is at rest, where valve body tends toward a closed position, but is maintained by a non-ferrous cable or rod, tube or spring in an open position on the walls of the fixture, until safety system conduit 100 fails. Upon failure of safety conduit system 100, the spring fails and valve bodies move to the preferred rest position, connecting with the valve seat resulting in valve closure. A second example is when a valve body is at rest, where valve body tends toward an open position, but is maintained by a rod in a closed position on the walls of the fixture, until safety system conduit 100 fails. Upon failure of safety conduit system 100, the rod pulls valve bodies to a closed position, connecting with the valve seat resulting in valve closure. When valve body and valve seats are in a closed valve position the combination prevents leakage or spillage of the fluids contained within the system.

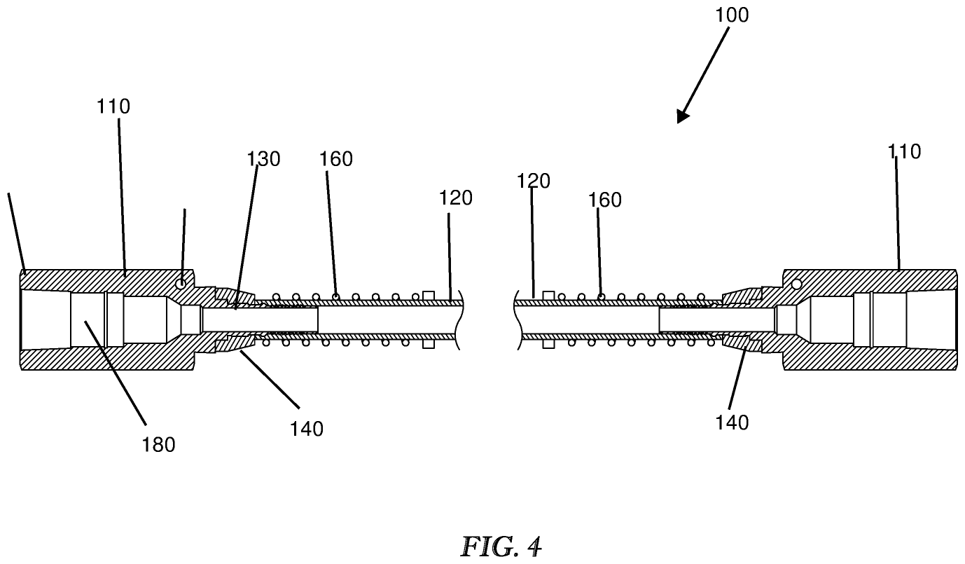

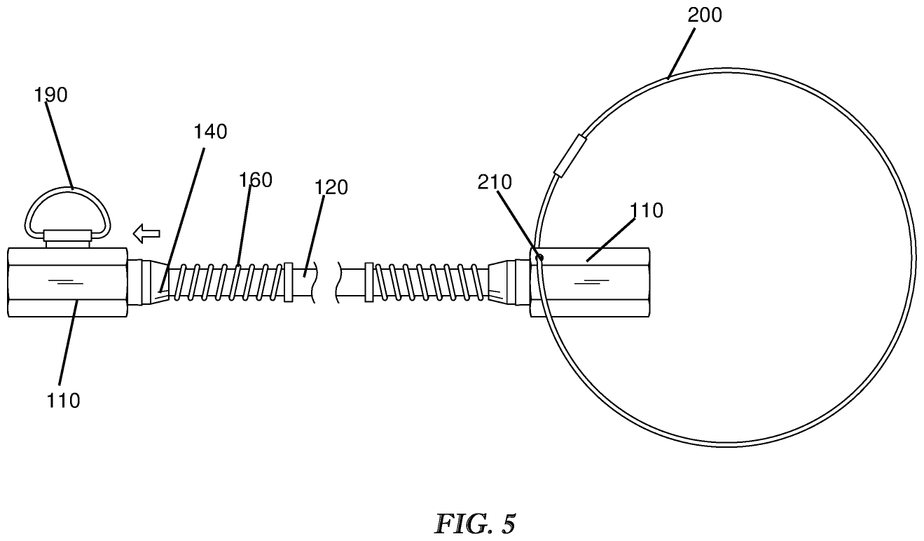

FIG. 4 is an example of the safety conduit system 100 with a cut away of the middle of the conduit 120. FIG. 5 shows an example of a handle 190 especially advantageous when the fixtures 110 and conduits 120 have diameters of more than about 10 inches.

Any size fixture 110 may have an aperture 210 to accommodate safety loop 200. Safety loop 200 is configured to wrap or hang around other elements of a handling system, and is advantageous for keeping the safety conduit system 100 in place on the handling system. The safety loop is especially helpful with smaller diameter fixtures 110 and conduits 120

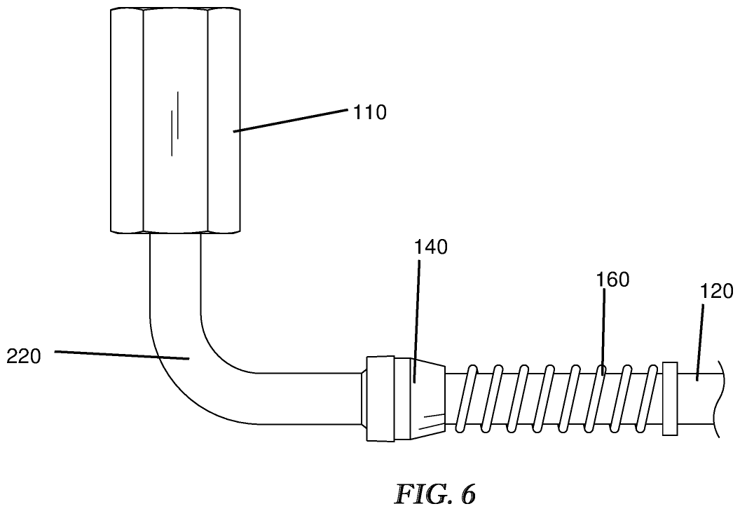

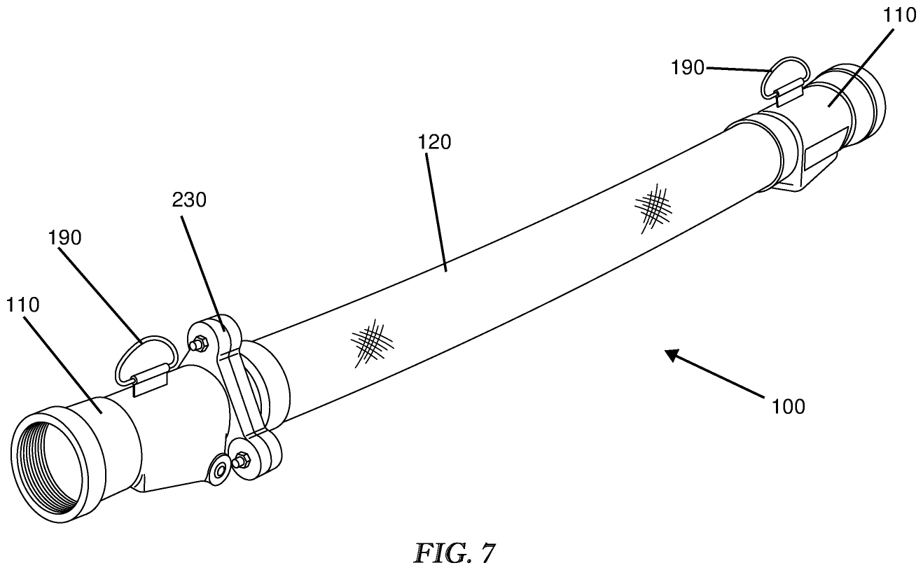

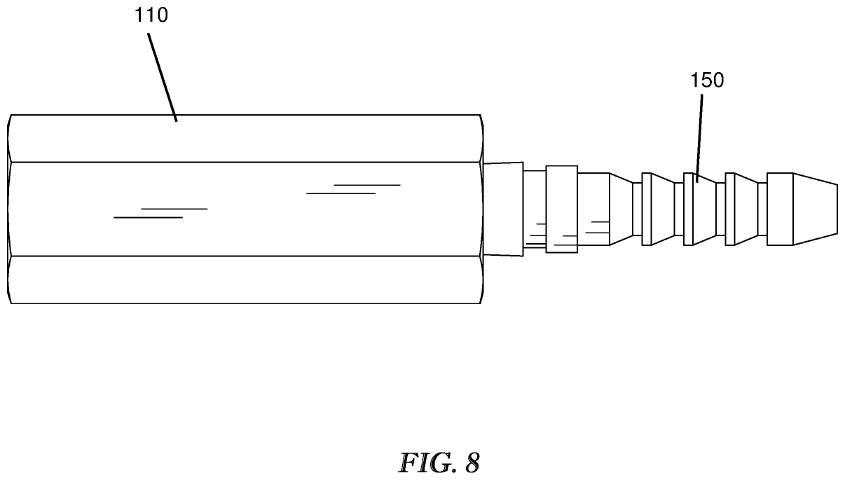

FIG. 6 illustrates an elbow connection 220 between fixture 110 and conduit 120. Elbow connection 220 is advantages in a tight configuration of the handling system such that a bend at elbow connection 220 would allow adequate exposure of fixture 110. FIG. 7, by way of example, is a larger version of safety conduit system 100 also having a seam 230 for bolts and/or pins to allow safety conduit system 100 to break away in the event of a system failure. FIG. 8 is a side view of a fixture 110 showing an embodiment of barbed teeth 150.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

I claim:

1. A safety conduit system comprising:
a. a conduit having first and second ends and inner and outer surfaces;
b. said conduit configured to withstand pressures exceeding 24,000 psi;
c. a fitting at each end of the conduit defining a valve seat configured to accept a valve body to define a closed valve;
d. means for keeping valve bodies and seats at an open position until conduit failure and means for movement of the valve body to meet valve seat to close a valve upon conduit fails;
e. wherein the fitting further comprises a tapered barbed segment on one end configured to fit into and connect the fitting to an inner portion on either end of the conduit;

2. The safety system for conduits of claim 1, wherein the material for the conduit is Ethylene Tetrafluoroethylene.

3. The safety system for conduits of claim 1, wherein the material for the conduit is Polyethylene-co-tetrafluoroethylene.

4. The safety system for conduits of claim 1, wherein the material for the conduit can withstand a burst pressure of between about 12,000 to 40,000 psi

5. The safety conduit system of claim 1, wherein the fitting comprises a tapered segment on one end and an opposite end having means to removably attach to a handling system of conduits.

6. The safety conduit system of claim 5, wherein tapered section has a plurality barbed teeth configured to be placed inside conduit and prevent removal of fixture from the conduit.

7. The safety conduit system of claim 6, wherein the plurality of barbed teeth is 5 or more barbed teeth.

8. The safety conduit system of claim 1, wherein the conduit further comprises a tubular core having inner and outer surfaces and further configured to have a plurality of tubular layers surrounding the outer surface of the tubular core; and an outer containment sleeve having an inner and outer surface the inner surface of the outer containment sleeve is surrounding the outer surface of the plurality of tubular layers.

9. The safety conduit system of claim 1, further comprising and elbow connection configured to connect the conduit to the fixture.

10. The safety conduit system of claim 1, further comprising an aperture on said fixture configured to receive a safety loop connected to the fixture.

11. The safety conduit system of claim 1, further comprising a handle configured to attach to said fixture.

12. The safety conduit system of claim 5, wherein the tapered end has means to removably attach to the conduit of the safety conduit system.

13. The safety conduit system of claim 12, wherein the fixtures and the conduits are removably attached at each respective ends, such that the system has interchangeable components.

14. The safety conduit system of claim 12, wherein the means to removably attach are mating screw threads.

15. The safety system for conduits of claim 1, comprising a crimp configured to secure attachment of the fitting to the conduit wherein said crimp is of at least 1-10 centimeters in length on the end of said conduit.
